(19) United States
(12) Patent Application Publication
(10) Pub. No.: US 2019/0051199 A1
(43) Pub. Date: Feb. 14, 2019

(54) Certifying User Knowledge and Skills

(71) Applicant: Turner Corbett, Fort Worth, TX (US)

(72) Inventor: Turner Corbett, Fort Worth, TX (US)

(21) Appl. No.: 16/102,397

(22) Filed: Aug. 13, 2018

Related U.S. Application Data
(60) Provisional application No. 62/544,473, filed on Aug. 11, 2017.

(51) Int. Cl. G09B 3/00

(52) U.S. Cl. CPC G09B 3/00

(57) ABSTRACT

Systems and methods for testing and certifying a user's skills and knowledge are provided. The system comprises a user testing and results-compiling processor configured to communicate with a plurality of external servers and a plurality of external user devices for the purposes of receiving testing or skills requests from a user, request and receive assessment or testing questions from third parties, administer testing questions to a user, and configured to calculate and certify results based on a user's answers to questions. The system can use a user's cumulative test results to compile a resumé of the user with skills and/or knowledge certified. The present invention solves problems with the currently available state of certification of user credentialing with regard to skills and/or knowledge by providing rigorous and verifiable testing and results to users and/or to interested third parties.

### FIELD OF THE INVENTION

The presently disclosed subject matter relates to testing and certification of skills and knowledge, and more specifically, to systems and methods for testing users, assessing skills and knowledge, and certifying a user's cumulative skills and knowledge to third parties.

### BACKGROUND OF THE INVENTION

Measuring knowledge and skills is crucial to many aspects of social and economic life, such as admission to schools and applications for employment. While many venues exist for such measurement, such as standardized testing, job interviews, and various specialized aptitude tests, such venues for measuring knowledge and skills are known to be imperfect and incomplete.

Standardized tests and board exams have multiple and significant shortcomings, as articles and research by their detractors point out, including the effectiveness of test preparation in raising scores. Both general-knowledge and subject-matter-specific standardized tests are susceptible to this and other strategies of gaming of scores, which limits their usefulness for assessment of an individual's knowledge or skills.

Likewise, job interviews tend to be brief and dominated by individual personality assessment, rather than a detailed view of the knowledge and skills that a person has acquired.

Other platforms exists for users to take tests, outside of the standardized-testing framework, but these lack the rigor of questions related to the material they purport to test, and have no guidelines to translate a user's performance into an assessment of the user's knowledge or skills. There are also platforms, including but not limited to social media platforms, where a user may voluntarily share information about what books they have read and/or what skills they have, but even when those platforms allow the user's colleagues or acquaintances to endorse someone's information as shared on that platform, there is no rigor or verification possible—such empty statements are of no use to schools or employers.

Accordingly, the problems with the prior art as related to certification of a user's knowledge or skills include strategies to inaccurately raise one's test score, lack of rigor in assessment or questions asked, and mere puffery without any ability to verify what a user asserts.

### SUMMARY OF THE INVENTION

The present invention meets all these needs, by disclosing systems, and methods, and instructions stored in non-transitory computer-readable media, for certifying user knowledge and skills. The goal of the present invention is to provide a solution for allowing users to choose which skills they want to certify, often in the form of books they have read; gather verified questions relating to a skill and/or book; test the user with some or all of those questions; and use the user's test results to build a certified resumé of the user's knowledge and skills.

In the present invention, a user can select books they have read and/or select skills the user wants to certify. The present invention gathers or has gathered test questions related to those books and/or skills, and initiates a test with that user; the present invention may gather or create test questions using artificial intelligence, machine learning, and/or deep learning. The present invention assesses the user's answers to test questions, to build a cumulative and on-going resumé of the user's knowledge and skills, in which the fact that the user has read the book or books, and absorbed the information, is reflected in the user's test answers. This solves the problem in the prior art of a lack of rigor or connection between the knowledge/skills the user wishes to certify, and the questions answered by the user.

By presenting questions that are specific to a book read by a user, or to a particular skill the user wishes to demonstrate having, the present invention avoids the problems faced by current standardized tests, of gaming of the test with strategies for improving scores, guessing answers, and obtaining a better score through test preparation.

Lastly, the present invention improves on the current state of self-reported skills or books read (including endorsements by peers or colleagues) by providing systems and methods for providing questions rigorously related to the material being tested, and verification of results of the user's answers to the questions.

The present invention then may share a user's resumé with interested third parties, including but not limited to schools and employers.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows an exemplary system configured to carry out the present invention, comprising a plurality of processors; a plurality of memory modules; a plurality of databases for storage of information related to tests and/or questions, books and/or skills, and user test answers and resumés; a plurality of computer-readable media for storing computer-readable instructions; a plurality of input devices; and a plurality of input/out modules for communication with external knowledge platforms, external recipient platforms, and/or user devices.

FIG. 2 shows an exemplary method for testing a user, assessing the user's skills and knowledge, and certifying the user's cumulative skills and knowledge, in response to testing or skills certification requests from the user, from the perspective of the inventive system.

FIG. 3 shows an exemplary method for testing a user, assessing the user's skills and knowledge, and certifying the user's cumulative skills and knowledge, in response to testing or skills certification requests from the user, from the perspective of a user device.

FIG. 4 shows an exemplary method for testing a user, assessing the user's skills and knowledge, and certifying the user's cumulative skills and knowledge, in response to testing or skills certification requests from the user, from the perspective of a third party.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses systems and methods for certifying user knowledge and skills. At a high level of overview, users register with the inventive system, and then may select one or more books or skills that the user wishes to certify her or his knowledge of. The user then may take tests, with the user's results being used for a cumulative resumé for the user. The inventive system carries this out by building one or more databases of books and test questions, which may be through the use of artificial intelligence, machine learning, and/or deep learning; associating the databases of books and test questions with skills; and using some of those test questions to test one or more users. The inventive system then builds a cumulative resumé for each user, which may be shared with recipient platforms that are interested in having verified testing results for one or more users. The inventive systems and methods, as described below in greater detail, carry out these functions of building resources for testing and verification of knowledge, and for building resumés for users, and sharing those resumés with recipient platforms. Each of the following inventive methods are performed by at least one computer processor executing computer program instructions tangibly stored on an least one non-transitory computer-readable medium. Each such computer processor performs at least one method by executing computer program instructions tangibly stored on an least one non-transitory computer-readable medium.

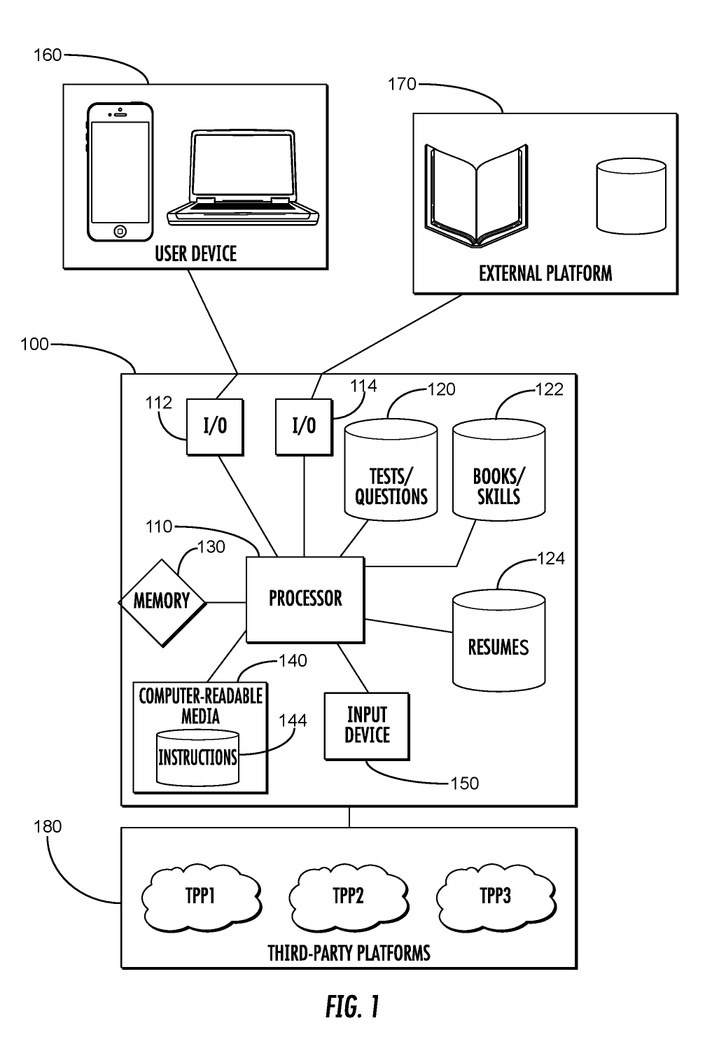

In the following descriptions of the inventive methods of the present disclosure, reference is made to structures and components of the system 100; for further description of such structures and components, refer to the discussion of FIG. 1, below.

FIG. 1 illustrates an exemplary system 100 configured to carry out the methods, 200, 300, and 400 of the present invention to test and certify user knowledge and skills by building databases of test questions and skills to test, providing and scoring tests, and building a user's resumé of certified knowledge and/or skills, which resumé may be shared with recipient platforms. The system 100 comprises a plurality of processors 110; a first input/out module 112 (hereafter, “input/output module” is abbreviated as “I/O”); a second I/O 114; a tests database 120; a skills database 122; a resumés database 124; a plurality of memory modules 130; a plurality of computer-readable media 140 for storing a plurality of computer-readable instructions 144 which may include but are not limited to instructions for carrying out any of the presently-disclosed methods 200, 300, and 400; and a plurality of input devices 150. In the various inventive methods 200, 300, and 400 described above, the components of the system 100 are communicably connected with each other to communicate with each other and transmit information to carry out the above-described inventive methods 200, 300, and 400.

The system 100 communicates with a plurality of exemplary user devices 160—a few possible user devices 160 are depicted in FIG. 1—in carrying out various of the inventive methods 200, 300, and 400 as previously described, specifically with the plurality of processors 110 utilizing the first I/O 112 to communicate with the plurality of user devices 160. The plurality of processors 110 are communicably connected with a plurality of external knowledge platforms 170, via the second I/O 114, to transmit or receive information about tests, test questions, books, and skills, utilizing the plurality of processors 110 and the plurality of memory modules 130, and the plurality of computer-readable instructions 144 stored in the plurality of computer-readable media 140. The system 100 may store information on tests, test questions, books, and skills, as well as information on the users and/or their answers and/or cumulative resumes, in some or all of the plurality of tests database 120, the plurality of skills database 122, and/or the plurality of resumés database 124. In some implementations of the present invention, it will be understood by one of skill in the art, one or more of the tests database 120, the skills database 122, and/or the resumés database 124 may be implemented as a single database, or there may be multiple instances of one or more of those databases.

When the system 100 carries out any of the inventive methods 200, 300, or 400, it utilizes the plurality of processors 110, which refers to the plurality of tests database 120, the plurality of skills database 122, and/or the plurality of resumés database 124, and refers to the plurality of computer-readable instructions 144 stored in the plurality of computer-readable media 140, to carry out the methods 200, 300, and 400 set forth in the plurality of computer-readable instructions 144. The plurality of processors 110 utilize the plurality of memory modules 130 to process the plurality of computer-readable instructions 144, and each of the methods 200, 300, and 400 are performed by at least one computer processor 110 executing computer-readable instructions 144 tangibly stored on an least one non-transitory computer-readable medium, which is one of the plurality of memory modules 130. Each such computer processor preforms at least one method by executing computer program instructions tangibly stored on an least one non-transitory computer-readable medium.

The plurality of processors 110 may be accessed using a plurality of input devices 150 for control or access to data. When the system 100 communicates with the plurality of user devices 160, the plurality of external knowledge platforms 170, and/or the plurality of external recipient platforms 180, it will be understood by one of skill in the art that the plurality of processors 110 may use the first I/O 112, the second I/O 114, or others in a plurality of I/O modules, to communicate with any of the platforms or devices external to the system 100.

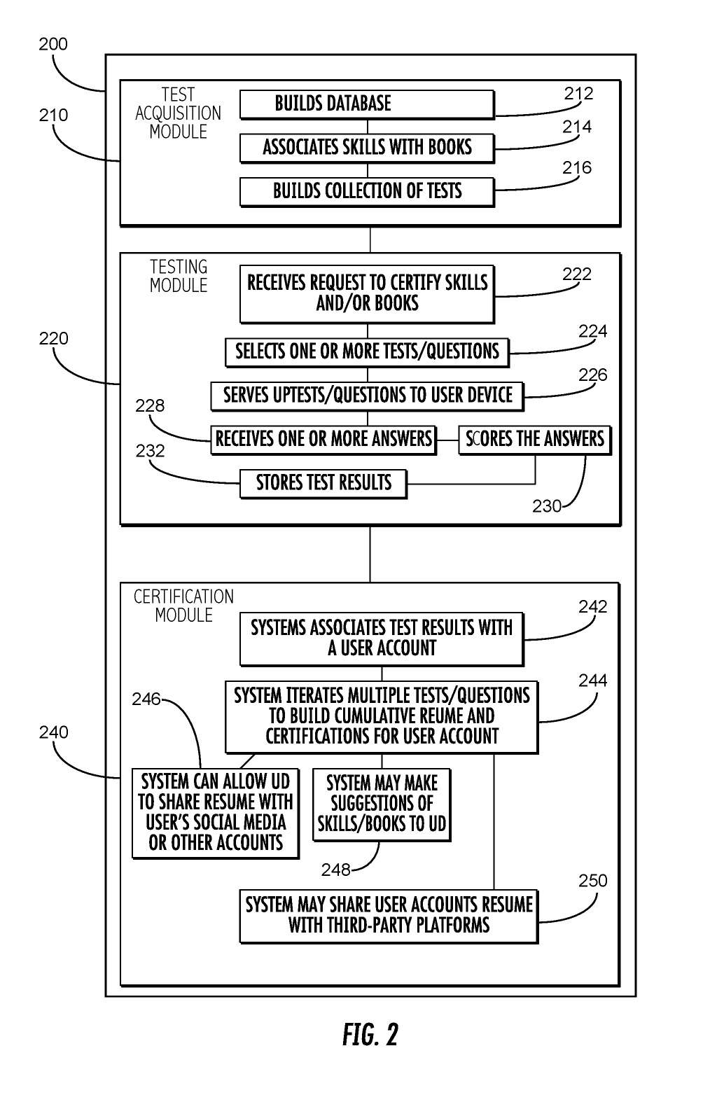

With reference to FIG. 2, a method 200 is presented, from the perspective of the system 100, of the inventive system 100 testing a user, assessing the user's skills and knowledge, and certifying the user's cumulative skills and knowledge, in response to testing or skills certification requests from the user, by implementing a test acquisition module 210, a testing module 220, and a certification module 240. The method 200 is stored in the plurality of computer-readable media 140, and at least one computer processor 110 executes computer-readable instructions 144 tangibly stored on an least one non-transitory computer-readable medium, which is one of the plurality of memory modules 130, to carry out method 200. The test acquisition module 210, the testing module 220, and the certification module 240 are advantageously implemented by the system 100 in that order, but it will be understood by one of skill in the art that, at times, each of the test acquisition module 210, the testing module 220, and the certification module 240 may at times be iterated independently of the other such modules.

In the test acquisition module 210, the system 100 communicates with one or more of the external knowledge platform 170 to build 212 the tests database 120 and the skills database 122. This entails the system 100 communicating with one or more of the external knowledge platform 170 to exchange information about books and skills that users may desire to certify their knowledge of, and associating those books and skills with rigorous questions to test knowledge of those books and skills. It will be understood by one of skill in the art that it is advantageous to have those questions prepared by the external knowledge platform 170. For instance, one such external knowledge platform 170 may be a publisher or author of a book, who may be well situated to create questions and answers, or may already have questions prepared for testing relevant material in the instant book. The inventive system 100 and methods 200, 300, and 400 provide a platform for independent testing and certification of knowledge, drawing on, among other sources, questions prepared by publishers, authors, or other external knowledge platforms 170. The system 100 then associates skills with books 214 and subsequently builds a test collection 216, with relevant information sorted and stored in the tests database 120 and the skills database 122. In some embodiments of the present invention, the present invention may gather or create test questions using artificial intelligence, machine learning, and/or deep learning, in collaboration with the external knowledge platforms 170 or running within the inventive system 100.

In the testing module 220, the system 100 receives 222 a request to certify knowledge of skills and/or books from a user, using one of the plurality of user devices 160. The system 100, using the plurality of computer-readable instructions 144, selects 224 one or more tests or questions relevant to the skills and/or books the user wishes to certify knowledge of, and thereafter delivers 226 tests and/or questions to the user device 160. At some later time, the system 100 receives 228 one or more answers to the tests and/or questions, and the system 100 then scores 230 the one or more answers. Thereafter, the system 100 stores 232 test results in the resumés database 124 and/or in the plurality of memory modules 130.

In the certification module 240, the system 100 associates 242 test results with that user's account (the account of the user signed in to or using the particular user device 160), building the cumulative resumé associated with that user. It has been found advantageous to have the system 100 iterate 244 multiple tests and/or questions to add to a user's cumulative resumé, building more certifications for that user, which increases the value of the cumulative resumé to that user, as it provides an increasingly full picture of what that user knows and has learned, contributing to the present invention's solutions to the problems in the prior art. The system 100 so iterates 244 by selectively repeating in the testing module 220 the steps or acts of selecting 224 one or more tests or questions relevant to the skills and/or books the user wishes to certify knowledge of, delivering 226 tests and/or questions to the user device 160, receiving 228 one or more answers to the tests and/or questions, and scoring 230 the one or more answers, and by selectively repeating in the certification module 240 storing 232 test results in the resumés database 124 and/or in the plurality of memory modules 130.

Thereafter, the system 100 can allow the user device 160 to share 246 that user's cumulative resumé with that user's social media or other accounts. The system 100 may also suggest 248 skills and/or books to the user, via the user's user device 160, for material, books, or skills which the user may wish to test, to add to the user's cumulative resumé. The system 100 may also, with consent from the user, share 250 a user account's cumulative resumé with a plurality of external recipient platforms 180, which may include schools, employers, military or service organizations, professional licensing organizations, or other interested parties.

It has been found advantageous to have the system 100 implement the test acquisition module 210 one or more times, as will be understood by one of skill in the art, prior to implementing the testing module 220, and likewise, it has been found advantageous to have the system 100 implement the testing module one or more times prior to implementing the certification module 240. In this way, the system 100 may build a substantial library of tests and skills in the tests database 120 and the skills database 122, respectively, prior to interacting with the plurality of user devices 160.

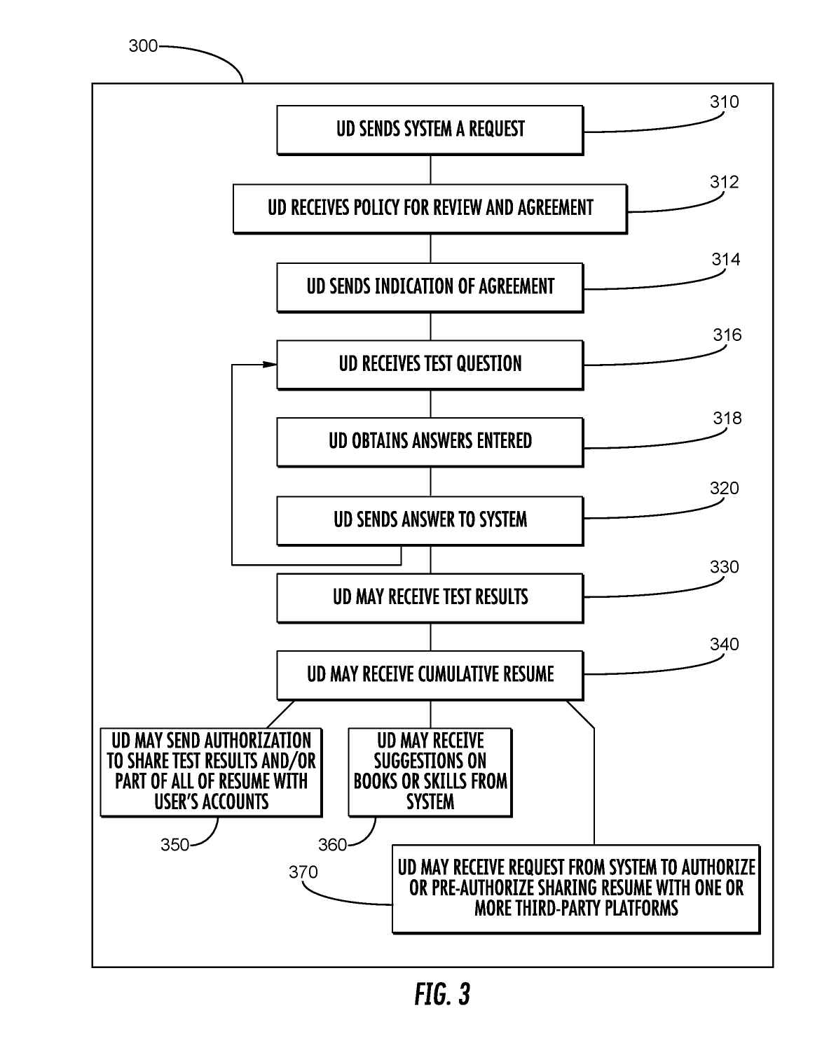

FIG. 3 depicts, from the perspective of one of the plurality of user devices 160, a method 300 of the inventive system 100 for testing a user, assessing the user's skills and knowledge, and certifying the user's cumulative skills and knowledge, in response to testing or skills certification requests from the user. The method 300 is stored in the plurality of computer-readable media 140, and at least one computer processor 110 executes computer-readable instructions 144 tangibly stored on an least one non-transitory computer-readable medium, which is one of the plurality of memory modules 130, to carry out method 300. In this inventive method 300, one of the plurality of user devices 160 sends 310 the system 100 a request to certify skills and/or knowledge and/or to certify having read a particular book. The user device 160 then receives 312 one or more policies from the system 100, or may not receive 312 such policies if the user using that user device 160 has previously agreed to such policies, which by way of example may include but are not limited to policies regarding cheating and honesty. Thereafter, the user device 160 sends 314 an indication of the user's acceptance or non-acceptance of the one or more policies. If the user device sends 314 an acceptance of all the policies, the user device 160 thereafter receives 316 a plurality of questions from the system 100. When or after the user device 160 obtains 318 an answer to each of one or more of the plurality of questions, the user device 160 sends 320 the plurality of answers to the system 100.

The user device 160 may iteratively receive 316 a next plurality of questions from the system 100, thereafter obtain 318 an answer to each of one or more of the next plurality of questions, and thereafter send 320 this next plurality of answers to the system 100, for as many times as the system sends additional pluralities of question to the user device 160. As will be understood by one of skill in the art, this has been found an advantageous method of testing skills or knowledge.

After sending 320 answers to the system 100, the user device 160 will receive 330 test results from the system 100, and thereafter, the user device 160 may receive 340 a cumulative resumé of the user who is using the user device 160. Thereafter, the user device 160 may send 350 to the system 100 authorization to share the user's test results and/or the user's cumulative resumé with the user's social media or other accounts, or with friends. The user device 160 may also receive 360 from the system 100 suggestions on books or skills that the user may wish to have certified by the system 100. The user device 160 may also receive 370 a request from the system 100 for authorization to share the user's test results and/or the user's cumulative resumé with one or more particular external recipient platforms 180, or with all interested or potential external recipient platforms 180.

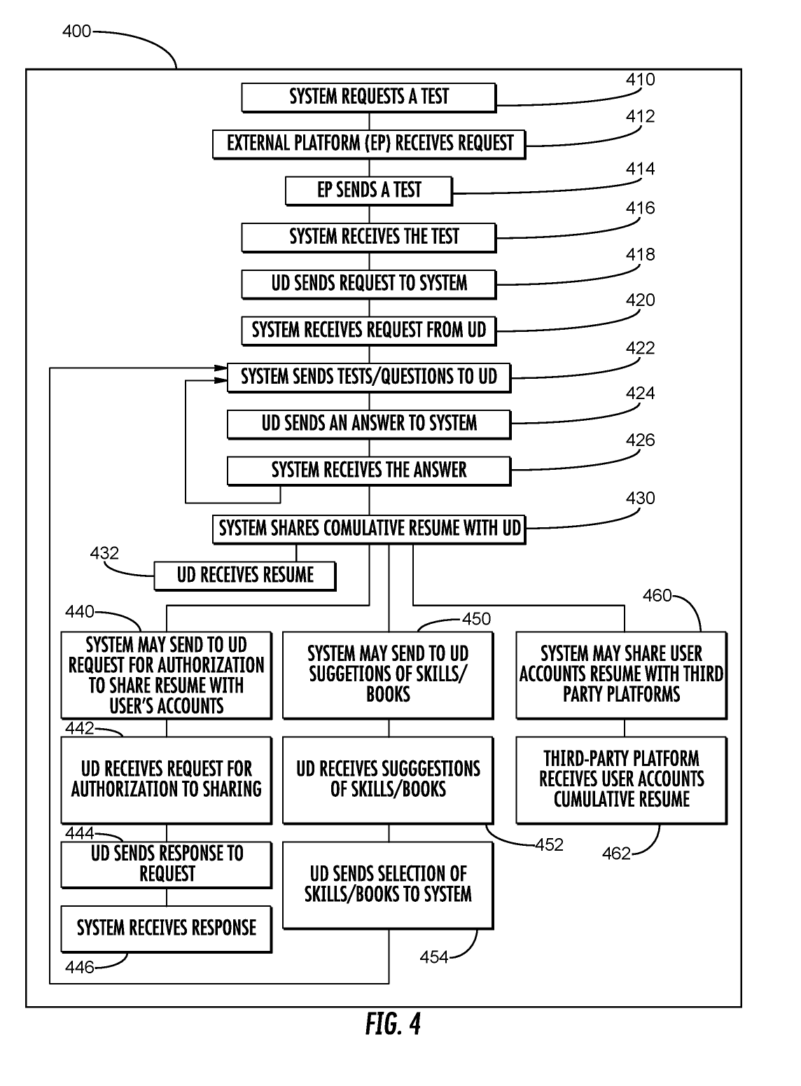

FIG. 4 illustrates, from the perspective of a third party external to all of the system 100, the plurality of user devices 160, the plurality of external knowledge platforms 170, and the plurality of external recipient platforms 180, a method 400 of the inventive system 100 for testing a user, assessing the user's skills and knowledge, and certifying the user's cumulative skills and knowledge, in response to testing or skills certification requests from the user. The method 400 is stored in the plurality of computer-readable media 140, and at least one computer processor 110 executes computer-readable instructions 144 tangibly stored on an least one non-transitory computer-readable medium, which is one of the plurality of memory modules 130, to carry out method 400. In this inventive method 400, the system 100 requests 410 a test and/or questions from one of the plurality of external knowledge platforms 170. Thereafter, the external knowledge platform 170 receives 412 the request from the system 100, and the external knowledge platform 170 then sends 414 a test and/or questions to the system 100. The system 100 then receives 416 the test and/or questions. In some embodiments of the present invention, when the system 100 receives 416 the test and/or questions, the system 100 may be receiving test questions created using artificial intelligence, machine learning, and/or deep learning, in collaboration with the external knowledge platforms 170 or running within the inventive system 100.

At another time, one of the plurality of user devices 160 sends 418 a request to the system 100 to certify skills and/or knowledge and/or to certify having read a particular book. The system 100 receives 420 the request from the particular user device 160, and thereafter, the system 100 sends 422 tests and/or questions to the user device 160. The user device 160 later sends 424 an answer to the system 100, and the system 100 receives 426 the answer from the user device 160. The system 100 and the user device 160 may, respectively, iterate sending 422 tests and/or questions to the user device 160, sending 424 one or more answers to the system 100, and receiving 426 the answer or answers. The system 100 and the user device 160 may so iterate as many times as is desired or applicable, as will be understood by one of skill in the art, for the relevant request to certify skills and/or knowledge and/or to certify having read a particular book.

At another time, the system 100 shares 430 a cumulative resumé of a user with the user device 160 associated with that user, or to which that user is logged in. The user device 160 receives 432 the cumulative resumé.

At another time, the system 100 sends 440 a request for authorization to the user device 160, to share the user's test results and/or the user's cumulative resumé with the user's social media accounts, friends, or others of the user's choosing. The user device 160 then receives 442 the request for authorization, and the user device 160 sends 444 a response to the request for authorization, after which the system 100 receives 446 the response to the request for authorization.

At another time, the system 100 sends 450 to the user device 160 suggestions of skills, books, and/or knowledge to certify. Thereafter, the user device 160 receives 452 the suggestions, and later, the user device 160 sends 454 to the system 100 a selection of skills and/or books and/or knowledge to certify. Thereafter, the system 100 may iterate sending 422 tests and/or questions to the user device 160.

At another time, the system 100 shares 460 the user account's cumulative resumé with one or more of the external recipient platforms 180, and the one or more external recipient platforms 180 then receive 462 the cumulative resumé associated with that user account.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor 110, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory 130 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A method, performed by at least one computer processor executing computer-readable instructions tangibly stored on an least one non-transitory computer-readable medium, for testing a user, assessing the user's skills and knowledge, and certifying the user's cumulative skills and knowledge, in response to testing or skills certification requests from the user, from the perspective of the inventive system, the method comprising:
in a test acquisition module, the system builds a tests database and a skills database; then
the system associates skills with books; then
the system builds a test collection; then
in a testing module, the system receives a request to certify knowledge of skills and/or books from a user using a user device; then
the system selects one or more tests or questions relevant to the skills and/or books the user wishes to certify knowledge of; then
the system delivers tests and/or questions to the user device; then
the system receives one or more answers to the tests and/or questions; then
the system scores the one or more answers; then
the system stores test results in a resumés database and/or in a plurality of memory modules; then
in a certification module, the system associates test results with that user's account.

2. The method of claim 1, the method further comprising the system iterates multiple tests and/or questions to add to the user's cumulative resumé, by:
selectively repeating in the testing module:
selecting one or more tests or questions relevant to the skills and/or books the user wishes to certify knowledge of,
delivering tests and/or questions to the user device,
receiving one or more answers to the tests and/or questions, and scoring the one or more answers, and
selectively repeating in the certification module storing test results in the resumés database and/or in the plurality of memory modules.

3. The method of claim 1, the method further comprising, after the system associates test results with that user's account, the system allows the user device to share that user's cumulative resumé with that user's social media or other accounts.

4. The method of claim 1, the method further comprising, after the system associates test results with that user's account, the system suggests skills and/or books to the user, via the user's user device, for material, books, or skills which the user may wish to test.

5. The method of claim 1, the method further comprising, after the system associates test results with that user's account, the system shares a user account's cumulative resumé with a plurality of external recipient platforms.

6. The method of claim 1, the method further comprising the system implements the test acquisition module one or more times prior to implementing the testing module.

7. The method of claim 1, the method further comprising the system implements the testing module one or more times prior to implementing the certification module.

8. A method, performed by at least one computer processor executing computer-readable instructions tangibly stored on an least one non-transitory computer-readable medium, for testing a user, assessing the user's skills and knowledge, and certifying the user's cumulative skills and knowledge, in response to testing or skills certification requests from the user, from the perspective of an external user device, the method comprising:
one of the plurality of user devices sends the system a request to certify skills and/or knowledge and/or to certify having read a particular book, then
the user device receives one or more policies from the system, and then the user device sends an indication of the user's acceptance or non-acceptance of the one or more policies.

9. The method of claim 8, the method further comprising the user device not receiving the one or more policies from the system if the user using that user device has previously agreed to such policies.

10. The method of claim 8, the method further comprising, after the user device sends an indication of the user's acceptance of all the policies, the user device receives a plurality of questions from the system, and later, when or after the user device obtains an answer to each of one or more of the plurality of questions, the user device sends the plurality of answers to the system.

11. The method of claim 10, the method further comprising, after the user device sends the plurality of answers to the system, the user device iteratively, for as many times as the system sends additional pluralities of question to the user device:
receives a next plurality of questions from the system, then
obtains an answer to each of one or more of the next plurality of questions, and then
sends this next plurality of answers to the system.

12. The method of claim 10, the method further comprising, after the user device sends the plurality of answers to the system, the user device receives test results from the system, and thereafter, the user device receives a cumulative resumé of the user who is using the user device.

13. The method of claim 12, the method further comprising, after the user device receives a cumulative resumé of the user who is using the user device, the user device sends to the system authorization to share the user's test results and/or the user's cumulative resumé with the user's social media or other accounts, or with friends.

14. The method of claim 12, the method further comprising, after the user device receives a cumulative resumé of the user who is using the user device, the user device receives from the system suggestions on books or skills that the user may wish to have certified by the system.

15. The method of claim 12, the method further comprising, after the user device receives a cumulative resumé of the user who is using the user device, the user device receives a request from the system for authorization to share the user's test results and/or the user's cumulative resumé with one or more particular external recipient platforms, or with all interested or potential external recipient platforms.

16. A method, performed by at least one computer processor executing computer-readable instructions tangibly stored on an least one non-transitory computer-readable medium, for testing a user, assessing the user's skills and knowledge, and certifying the user's cumulative skills and knowledge, in response to testing or skills certification requests from the user, from the perspective of a third party external to all of the system, the plurality of user devices, the plurality of external knowledge platforms, and the plurality of external recipient platforms, the method comprising:
the system requests a test and/or questions from one of the plurality of external knowledge platforms; then
the external knowledge platform receives the request from the system; then
the external knowledge platform sends a test and/or questions to the system; then
the system receives the test and/or questions; and at another time, one of the plurality of user devices sends a request to the system to certify skills and/or knowledge and/or to certify having read a particular book; then
the system receives the request from the particular user device; and thereafter,
the system sends tests and/or questions to the user device; then
the user device sends an answer to the system; and then
the system receives the answer from the user device.

17. The method of claim 16, the method further comprising the system iterates sending tests and/or questions to the user device, and the user devices iterates sending one or more answers to the system, and the system iterates receiving the answer or answers.

18. The method of claim 16, the method further comprising, after the system receives the answer from the user device, the system shares a cumulative resumé of a user with the user device associated with that user, or to which that user is logged in, and the user device receives the cumulative resumé.

19. The method of claim 16, the method further comprising, after the system receives the answer from the user device,
the system sends a request for authorization to the user device; then
the user device receives the request for authorization; then
the user device sends a response to the request for authorization; then
the system receives the response to the request for authorization.

20. The method of claim 16, the method further comprising, after the system receives the answer from the user device,
the system sends to the user device suggestions of skills, books, and/or knowledge to certify; then
the user device receives the suggestions; then
the user device sends to the system a selection of skills and/or books and/or knowledge to certify.

21. The method of claim 20, the method further comprising the system iterating sending tests and/or questions to the user device.

22. The method of claim 16, the method further comprising, after the system receives the answer from the user device,
the system shares the user account's cumulative resumé with one or more of the external recipient platforms; then
the one or more external recipient platforms receive the cumulative resumé associated with that user account.

23. A system of communicably connected components comprising at least one non-transitory computer readable medium containing computer-readable instructions executable by at least one computer processor to perform a method for testing a user, assessing the user's skills and knowledge, and certifying the user's cumulative skills and knowledge, in response to testing or skills certification requests from the user, the system comprising:
a plurality of processors;
a plurality of memory modules;
a plurality of databases for storage of information related to tests and/or questions;
a plurality of databases for storage of information related to books and/or skills;
a plurality of databases for storage of information related to user test answers and resumés;
a plurality of input devices;
a plurality of computer-readable media for storing computer-readable instructions; and
a plurality of input/out modules for communication with external knowledge platforms, external recipient platforms, and/or user devices.

24. The system of claim 23, in which the plurality of computer-readable instructions comprise stored instructions for one or more of:
testing a user, in response to testing or skills certification requests from the user; or
assessing the user's skills and knowledge, in response to testing or skills certification requests from the user; or
certifying the user's cumulative skills and knowledge, in response to testing or skills certification requests from the user.

25. Computer-readable instructions, stored in computer-readable media, for testing a user, assessing the user's skills and knowledge, and certifying the user's cumulative skills and knowledge, in response to testing or skills certification requests from the user.
